(19) United States
(12) Patent Application Publication
(10) Pub. No.: US 2004/0001523 A1
(43) Pub. Date: Jan. 1, 2004

(54) Optimizing power for second laser

(76) Inventors: Kevin Holsinger, Menlo Park, CA (US); John Philip Ekstrand, Palo Alto, CA (US)

Correspondence Address: HELLER EHRMAN WHITE & MCAULIFFE LLP, 275 MIDDLEFIELD ROAD, MENLO PARK, CA, 94025-3506, US

(21) Appl. No.: 10/301,502

(22) Filed: Nov. 20, 2002

Related U.S. Application Data
(60) Provisional application No. 60/331,967, filed on Nov. 20, 2001.

(51) Int. Cl. H01S 3/09

(52) U.S. Cl. 372/69

(57) ABSTRACT

Feedback from a power monitor sampling a portion of the output beam of an optical resonator is used to control the position of a pump beam relative to a second laser. The pump beam position or orientation is adjusted in response to a dither signal imposed on the position or tilt of an external optic or mirror in order to maximize the efficiency of the second laser in converting pump power to output power. Feedback based on the response of the power monitor is used to control the position or tilt of the mirror or optic to which the dither was applied.

### CROSS-REFERENCE TO APPLICATIONS

This application claims the benefit of U.S. Ser. No. 60/331,967, filed Nov. 20, 2001, which application is fully incorporated by reference herein.

### BACKGROUND

1 . Field of the Invention

The present invention is directed to an optical system with a cavity pumped by a pump source, and more particularly to an optical system where an efficiency of the cavity is maximized by adjusting a position of the pump beam relative to the cavity.

2. Description of the Related Art

In recent years, medical and industrial applications using laser systems have proliferated. As the lasers have become more reliable and commonplace, there has also been a greater emphasis on improving control of the laser parameters in order to improve outcomes in practical settings. Providing the required controls presents a greater challenge as increasingly complex laser systems are being introduced into applications which place stringent demands on performance and operating lifetime even though the preferred devices are required to be more compact and cost effective. Ultra-fast lasers, build-up cavities involving resonant frequency doubling, systems including optical parametric conversion devices and multiple harmonic modules and high power fiber lasers are all examples of complex laser systems requiring sophisticated controls to perform their intended functions.

Ultrashort pulse lasers have, in particular, been promoted as an effective new tool for a variety of medical and industrial applications, and especially where small interactions zones, fine feature sizes and limited collateral damage are considered highly beneficial. Examples include metrology measurements, two-photon microscopy, material processing, stereolithography and corneal sculpting procedures. In the case of material processing applications ultrafast lasers exploit localized laser induced breakdown mechanisms to provide submicron processing capability. Some applications exploit the ability of ultrafast lasers to ablate surface regions that are even smaller than their minimum, diffraction-limited, spot size. Many micro-machining, inscription, and hole drilling procedures have been proposed that take advantage of the high degree of precision provided by ultrafast interactions. Examples include drilling holes with sub-wavelength pitch to produce photonic crystals as described in U.S. Pat. No. 6,433,305, removal of biological and other types of material while incurrring minimal collateral damage and attaining greatly increased cut quality, as taught in U.S. Pat. No. 5,720,894, precise surface ablation in either opaque or transparent materials as described in U.S. Pat. Nos. 5,656,186 and 6,333,485, and inscription of micro patterns in various materials.

Note is taken of the fact that the efficacy of micro-machining procedures carried out with ultrashort pulse lasers depends in a large measure on the precision of controls provided by the system of the key output laser parameters including power, pulse energy and/or pulse width. In particular, controlling and stabilizing the output power are essential to the precision with which micro-holes can be drilled, micro-patterns can be inscribed or clean repeatable cuts can be made. Procedure repeatability and high throughputs are especially important considerations for virtually all industrial, biological and surgical applications which contemplate the use of ultrafast lasers.

Another especially good example of an application requiring a high degree of control is provided by emerging metrology applications such as the ultrasonic short pulse technique successfully developed into a semiconductor inspection tool. The technique, described in U.S. Pat. Nos. 5,959,735 (Optical stress generator and detector) and 5,748,317 (Apparatus and method for characterizing thin film and interfaces using an optical heat generator and detector), both by Maris et al, uses femtosecond laser pulses to produce ultrasonic echoes which are analysed to derive the thickness of single or multi-layer metal films used in integrated circuit manufacturing. With metal layers ranging from under 20Å to over 5 μm, high precisions with better than 1-2% repeatability are required along with high throughput rates. Precise control of key laser parameters is therefore essential for this application. In particular, variations in power can contribute to nonuniformities in thickness measurements which can compromise the measurements.

In many of foregoing applications, it is required that the laser be capable of hands-off reliable operation for prolonged periods of time in an industrial or medical setting. At the same time during the time the output laser beam is coupled to a work piece, the laser must provide power levels and other operational characteristics that are as constant as possible and be free of long term drift or unpredictable power instabilities. Generally, it is known that uncontrolled fluctuations in power or other laser parameters such as the pulse width, wavelength or beam divergence lower the accuracy of the laser interactions with a target material and compromise the system performance. Whereas methods of stabilizing operating laser parameters are known in the art, many such techniques require numerous additional components and are too complex to implement in an industrial setting especially where reliable throughputs and space considerations are paramount. It is therefore highly desirable to provide a laser system with improved reliability and stabilized output control features on a fine scale using the most expedient and cost effective means.

Typically, the more complex laser systems that are the subject of the present invention comprise at least two or more key subsystems, each of which may be a laser cavity or optical system. In this case changing parameters of an output beam which is the one delivered to the target requires controlling an existing input system or subsystem with its own fully designed control electronics and drivers.

For example, the pump laser may comprise a commercially designed diode pumped green laser used to drive a tunable IR laser such as a Ti:sapphire laser designed to provide ultrashort pulses. Alternatively the tunable laser may comprise an optical parametric converter or a Raman shifter to provide a fixed set of wavelengths. In still other examples the optical system may include build up cavities for resonant harmonic conversion or an injection seeded amplifier in a MOPA configuration.

In all of these cases, controlling and adjusting the output power of a laser consisting of one or more complex subsystems can be a major issue.

There is therefore a need for techniques that can provide a high degree of control of selected properties of the output from optical systems that may include one or more laser subsystems. There is a particular need for cost effective techniques that provide a means of compensating for misalignment that can degrade system performance in an industrial environment. There is further need to be able to make these adjustments in a way that enhances system reliability and extends system lifetime in medical and industrial applications. This invention not only provides an important tool for meeting these criteria, but also makes possible extended operation of a complex optical system without need for frequent maintenance. The system can remain enclosed for greatly extended periods of operation, meaning that it is less likely to be adversely affected by an industrial environment.

Control of a pump beam into a second laser is the subject of U.S. Pat. No. 4,514,849 (Dye Laser with Rotating Wedge Alignment Servo), by Witte et al. They describe a servo system in which a rotating wedge is used to produce a movement of a pump beam into a second laser, with the movement defining a conical surface. The resultant modulation of the power of the second laser is used to create a feedback control to a motor-driven mirror to direct the beam to a spot in the second laser that maximizes the output power. The use of the rotating wedge approach has several disadvantages. The wedge is fixed, such that the amplitude of the dither cannot be adjusted. The final alignment can only be an average of the positions of the pump beam as it traces a circular path in the gain medium while it is driven by the feedback loop toward the position that produces maximum power. As a result, the pump beam can never pass through the position of best alignment while the dither is in process, because the best it can do is to continue to circle it. Witte et al used the error signal induced by rotating the wedge to control the angular tilt of a motor-driven mirror. This method requires that at least two optical elements must undergo mechanical motion. The Witte system neither teaches nor suggests dithering the positioning mirror to be aligned, which would reduce the number of moving optical elements to one.

In U.S. Pat. No. 5,033,061 (Laser alignment servo method and apparatus), Hobart et al apply the concept of dithering the angular alignment of an intracavity mirror to optimizing the performance of the laser using feedback to adjust the alignment of the same mirror. In this case the dithered optic is part of the laser for which power is being maximized rather than being an external optic that is optimizing the position or orientation of a pump beam. There will always be some resultant modulation of the output power, which means that there will be some induced noise at the dither frequency. One way to minimize the noise contribution is to use the error signal to maximize pumping efficiency while holding the output power fixed.

This invention utilizes movement of a mirror or other suitable optical element external to the second laser to achieve efficient pumping of the second laser by using feedback from an external power monitor that samples a portion of the output beam from the second laser. In this case a dither is applied to the mirror or optic for which alignment is being adjusted. The dither can be applied in each of two orthogonal directions and the amplitude of the dither can be adjusted electronically to minimize the introduction of noise in the output of the pumped laser. The movement of the optic as well as the applied dither motion can be made using a variety of transducers, such as piezoelectric devices, stepper motors, DC motors, and electromagnetic transducers. The movement of the optic in response to the feedback can be made using the same transducers that apply the dither motion or by a different transducer. Movement of the optic along orthogonal directions can be made by using the same or different transducers. Furthermore, the dither motion applied to the optic along orthogonal directions can be made with the same or different transducers. Simplicity is best served by using the same transducer type for all movements of the optic, such as an arrangement of two or more piezoelectric stacks that can supply many microns of motion with an applied voltage of below one hundred volts.

Use of this invention provides advantages for system stability against misalignment that might result from changes of environmental conditions such as temperature changes or from drifts in alignment of optical components. In addition, changes of beam pointing in the pump laser that might result from thermal effects can be compensated by the automated adjustment of the controlled mirror or optic. As a result, use of the technique results in extended reliability and lifetime enhancement for the second laser.

### SUMMARY

Accordingly, an object of the present invention is to provide an improved optical system that includes a cavity pumped by a pump source.

Another object of the present invention is to provide an optical system with a cavity pumped by a pump source with improved efficiency of the cavity.

A further object of the present invention is to provide an optical system with a cavity pumped by a pump source that maximizes the efficiency of the cavity.

These and other objects of the present invention are achieved in an optical system with a pump source that produces a first output beam. A cavity is pumped by the first output beam and produces a second output beam. A power monitor is positioned to receive at least a portion of the second output beam. In response to a signal from the power monitor an efficiency of the cavity is maximized by adjusting a position of the first output beam relative to the cavity.

In another embodiment of the present invention, an optical system has a pump source that produces a first output beam. A cavity is pumped by the first output beam and produces a second output beam. A first power monitor is positioned to receive at least a portion of the second output beam. The first power monitor provides an input to a summing junction coupled to the pump source. In response to a signal from the power monitor, an efficiency of the cavity is maximized by adjusting a position of the first output beam relative to the cavity.

### BRIEF DESCRIPTION OF THE DRAWINGS

FIG. 1 illustrates one embodiment of the optical system of the present invention.

FIG. 2 illustrates one embodiment of the cavity device of FIG. 1.

FIG. 3 illustrates another embodiment of the cavity device of FIG. 1.

FIG. 4 illustrates another embodiment of the cavity device of FIG. 1.

### DETAILED DESCRIPTION OF THE PREFERRED EMBODIMENTS

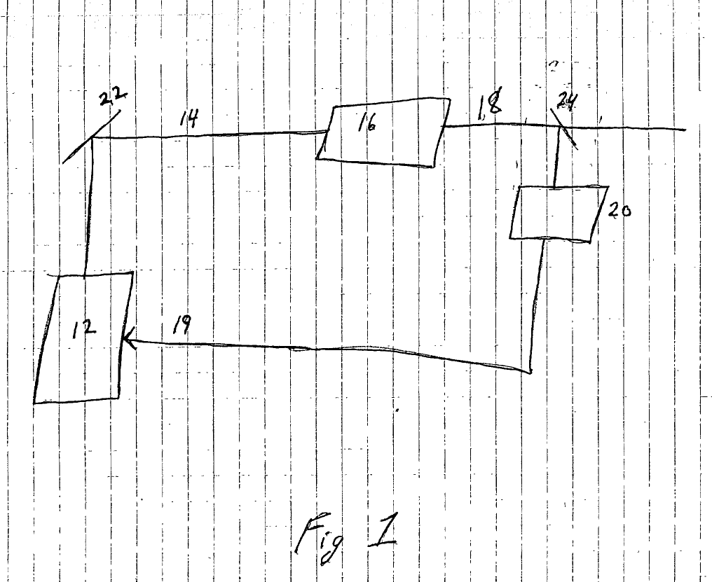

In one embodiment of the present invention, illustrated in FIG. 1, an optical system 10 has a pump source 12 that produces a first output beam 14. A cavity 16 is pumped by first output beam 14 and produces a second output beam 18. A power monitor 20 is positioned to receive at least a portion of second output beam 18. In response to a signal 19 from power monitor 20, an efficiency of cavity 16 is maximized by adjusting a position of first output beam 14 relative to cavity 16. Pump source can include a second harmonic generator such as one made of LBO.

A reflector 22 can be positioned between pump source 12 and cavity 16 in order to directed first output beam 14 into cavity 16. Reflector 22 is preferably movably mounted, and can be mounted to be dithered. A response of second output beam 18 to this dithering can be used to determine an orientation of reflector 22 which maximizes power of second output beam 18. The response of second output beam 18 can also be used to minimize power of first output beam 14 while maintaining the same power of second beam 18.

A beam splitter 24 can be included and can be positioned along a beam path of second output beam 18. Beam splitter 24 directs at least a portion of second output beam 18 to power monitor 20.

Pump source 12 can be an optically pumped laser including but not limited to a diode pump source and can be fiber coupled. Pump source 12 can include a gain medium including but not limited to Nd:YVO₄, Nd:YAG, Nd:YLF, Nd:Glass, Ti:sapphire, Cr:YAG, Cr:Forsterite, Yb:YAG, Yb:KGW, Yb:KYW, Yb:glass, KYbW and YbAG. In one embodiment, the gain medium is Nd:YVO₄ with a doping level of less than 0.5%.

Cavity 16 can be a variety of devices including but not limited to an OPO, a build-up cavity, a Ti:sapphire laser, a non-linear device, a frequency doubler and the like. The build up cavity can include non-linear optical components.

One or both of pump source 12 or cavity 16 can include a modelocking device. Suitable mode-locking devices include but are not limited to, a multiple quantum well saturable absorber, a non-linear mirror mode locker, a polarization coupled mode locker, an acousto-optic modulator, and the like.

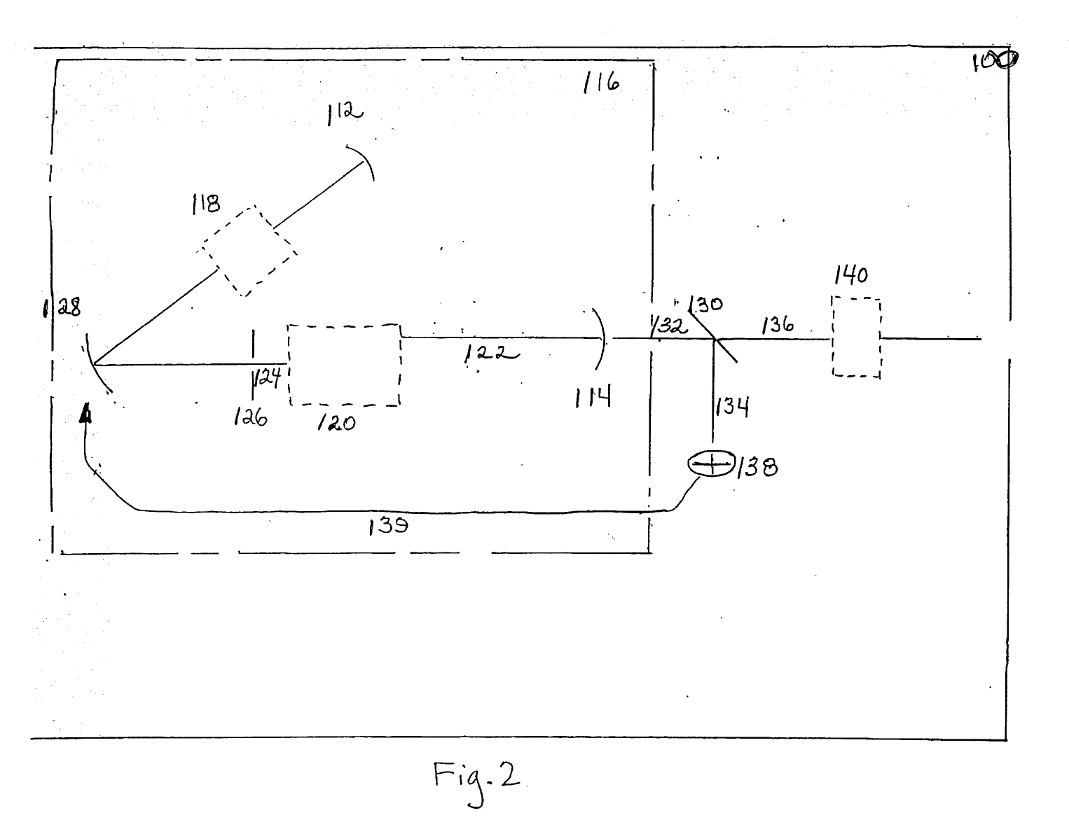

Referring now to FIG. 2, one embodiment of cavity 16, denoted as 100, includes an end mirror 112 and an output coupler 114 that generally define a resonator cavity 116. -Output coupler 114 can be curved or flat. Resonator cavity 116 produces an output beam with selected spectral components.

A gain medium 118 is positioned in resonator cavity 116. A dispersion member 120 is positioned in resonator cavity 116. Dispersion member 120 creates a spread of spectral components of the intracavity beam in a lateral direction. Dispersion member 120 can be a variety of optical elements including but not limited to a grating pair, and the like.

An aperture member 126 is positioned in resonator cavity 116 in a path of the intracavity beam. Aperture member 126 defines an aperture that provides a low loss intracavity beam path for a range of spectral components. At first position 122, the range of spectral components of the intracavity beam follows a single beam path. When the intracavity beam travels from position 122 to position 124, dispersion member 120 creates a spatial spread of the range of spectral components. When the intracavity beam travels from position 124 to position 122, the reverse process occurs.

A movably mounted mirror 128 is provided. In response to a feedback signal movably mounted mirror 128 maintains the output beam at a same position at output coupler 114. Movably mounted mirror 128 can be rotatably mounted. A variety of different mechanisms can be used to mount mounted mirror 128 including but not limited to the use of a piezoelectric device, and the like. Movably mounted mirror 128 holds the intracavity beam at a fixed position relative to the aperture to maintain a stable wavelength of the output beam. Movably mounted mirror 128 can be positioned between the aperture member 126 and end mirror 112.

Aperture member 126 blocks non-selected spectral components of the intracavity beam that are incident on gain medium 118. Aperture member 126 has an aperture that passes the selected spectral components that are reflected from end mirror 112, and oscillate in resonator cavity 116. The non-selected spectral components do not pass through the aperture and do not oscillate in resonator cavity 116.

A beam splitter 130, or other suitable device, can be positioned at an exterior of resonator cavity 116 along a beam path 132 of the output beam, and creates first and second beams 134 and 136. A detector 138 is positioned along a beam path of beam 134. In response to the detection of beam 134, detector 138 produces a feedback signal 139 for movably mounted mirror 128. A variety of different detectors 138 can be utilized including but not limited to a position sensitive detector, a quad-cell detector, bi-cell detector, and the like.

Oscillator system 100 can also include a non-linear device 140 including but not limited to a frequency doubler. Additional fold mirrors and other optical components can be included.

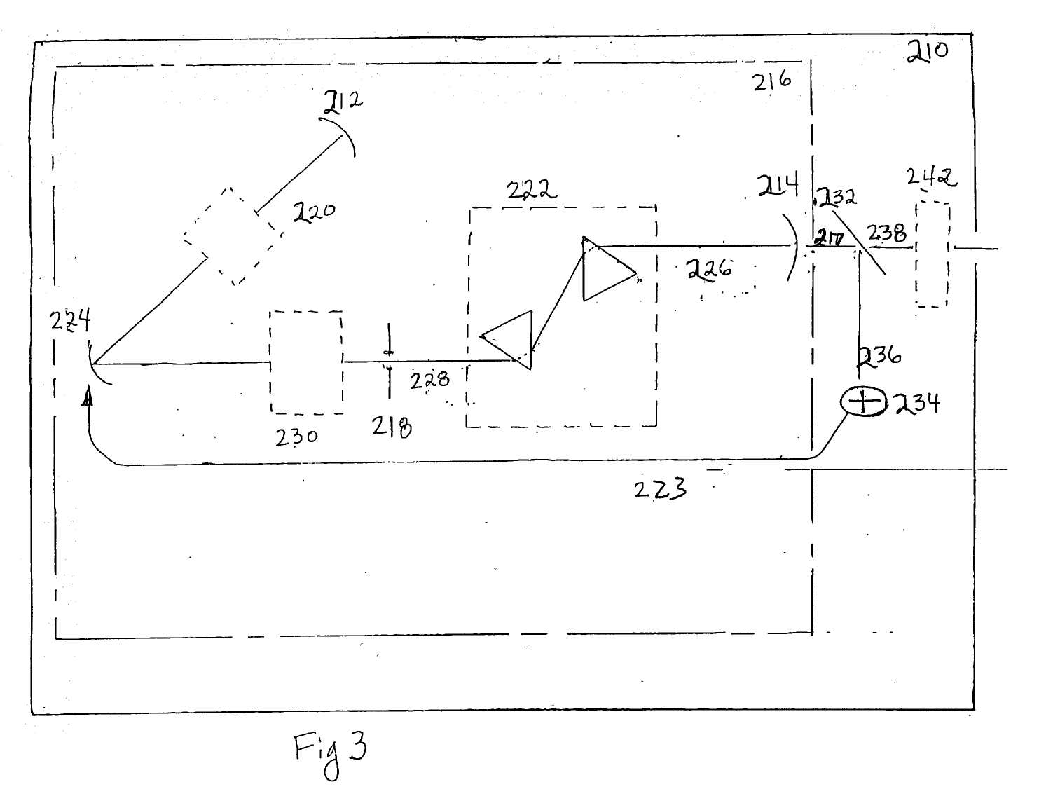

With reference now to FIG. 3, another embodiment of cavity 16 is an optical oscillator system 210 with an end mirror 212 and an output coupler 214 that define a resonator cavity 216 for an intracavity beam that produces an output beam 217 of selected spectral components. A gain medium 220 is positioned in resonator cavity 216. An aperture member 218 is positioned in resonator cavity 216 in a path of the intracavity beam. Aperture member 218 has an aperture that provides a low loss intracavity beam path for a range of spectral components. A first prism pair 222 is positioned between aperture member 218 and output coupler 214. A movably mounted mirror 224 is provided. In response to a feedback signal 223, movably mounted mirror 224 maintains the output beam at a same position at output coupler 214.

At a first position 226, the range of spectral components of the intracavity beam follows a single beam path. When the intracavity beam travels from position 226 to position 228, first prism pair 222 creates a spatial spread of the range of spectral components. When the intracavity beam travels from position 228 to position 226, the reverse process occurs. Oscillator system 210 can include a retro-reflector 230, or suitable optical device.

A beam splitter 232 and a detector 234 can be positioned at the exterior of resonator cavity 216. Beam splitter 232 splits output beam 217 into beams 236 and 238. Detector 234 is positioned along a path of beam 236. In response to beam 236, detector 234 produces the feedback signal 223 to movably mounted mirror 224. A non-linear device 242, including but not limited to a frequency doubler, can be included in optical oscillator system 210. Oscillator system 210 can include additional optical components

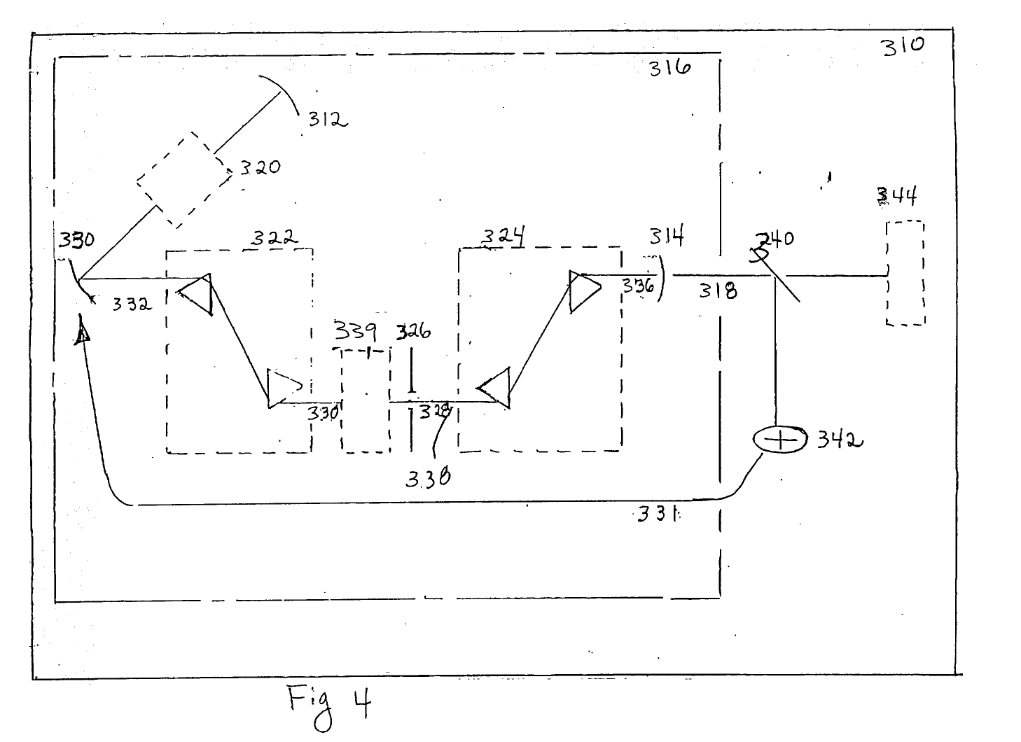

In another embodiment of the present invention, illustrated in FIG. 4, cavity 316 is an optical oscillator system 310 and includes an end mirror 312 and an output coupler 314 that define a resonator cavity 316 for an intracavity beam. Resonator cavity 316 produces an output beam 318 with selected spectral components. A gain medium 320 is positioned in resonator cavity 316. A first prism pair 322 is positioned in resonator cavity 316. A second prism pair 324 is positioned between first prism pair 322 and output coupler 314. An aperture member 326 is positioned between first and second prism pairs 322 and 324 in a path 328 of the intracavity beam. Aperture member 326 defines an aperture that provides a low loss intracavity beam path for a range of spectral components. A movably mounted mirror 330 is provided. In response to a feedback signal 331, movably mounted mirror 330 maintains output beam 318 at a same position at output coupler 314. First prism pair 322 has first and second sides 330 and 332, and second prism pair 324 has first and second sides 336 and 338.

When the intracavity beam travels from first side 336 to second side 338, second prism pair 324 creates a spatial spread of the spectral components. When traveling from first side 330 to second side 332, first prism pair 322 reverses the process. A retro reflector 339, or other suitable optical device, can be included.

A beam splitter 340 and a detector 342 can be positioned at the exterior of resonator cavity 316. Beam splitter 340 and detector 342 provide the some functions as beam splitters 130, 232 and detectors 138, 234 respectively. A nonlinear device 344 can be included. Oscillator system 310 can include additional optical elements.

While the invention has been described in connection with what is presently considered to be the most practical and preferred embodiment, it is to be understood that the invention is not limited to the disclosed embodiment, but on the contrary it is intended to cover various modifications and equivalent arrangement included within the spirit and scope of the claims which follow.

What is claimed is:

7. The system of claim 6, wherein the gain medium is Nd:YVO₄.

8. The system of claim 7, wherein the Nd:YVO₄ gain medium has a doping level of less than 0.5%.

9. The system of claim 1, wherein the pump source is fiber coupled.

10. The system of claim 1, wherein at least one of the pump source or the cavity includes a mode locking device.

11. The system of claim 10, wherein the mode locking device is a multiple quantum well saturable absorber.

12. The system of claim 10, wherein the mode locking device is a non-linear mirror mode locker.

13. The system of claim 10, wherein the mode locking device is a polarization coupled mode locker.

14. The system of claim 10, wherein the mode locking device is an acousto-optic modulator.

15. The system of claim 1, wherein the pump source includes a second harmonic generator.

16. The system of claim 15, wherein the second harmonic generator is made of LBO.

17. The system of claim 1, wherein the cavity is an OPO.

18. The system of claim 1, wherein the cavity is a build up cavity.

19. The system of claim 18, wherein the build up cavity includes non-linear optical components.

20. The system of claim 1, wherein the cavity is a Ti:sapphire laser.

21. The system of claim 1, wherein the cavity is a non-linear device.

22. The device of claim 1, wherein the cavity is a frequency doubler.

23. The system of claim 3, wherein the reflector is movably mounted.

24. The system of claim 3, wherein the reflector is mounted to be dithered.

25. The system of claim 24, wherein a response of the second output beam to dithering of the reflector is used to determine a reflector orientation which maximizes power of the second output beam.

26. The system of claim 24, wherein a response of the second output beam to dithering of the reflector is used to determine a reflector orientation to minimize power of the first beam and maintain a same power of the second beam.

27. The system of claim 1, further comprising:
a beam splitter positioned along a beam path of the second output beam, the beam splitter directing the at least a portion of the second output beam to the power monitor.

28. The system of claim 1, wherein the cavity comprises:
an end mirror and an output coupler defining a resonator cavity for an intracavity beam and producing an output beam with selected spectral components;
a gain medium positioned in the resonator cavity;
an aperture member positioned in the resonator cavity in a path of the intracavity beam, the aperture member defining an aperture that provides a low loss intracavity beam path for a range of spectral components;
a dispersion member with first and second sides and positioned in the resonator cavity, wherein when the intracavity beam travels from the first side to the second side dispersion member creates a spatial spread process of the range of spectral components, and from the second side to the first side reverses the process; and
a movably mounted mirror, wherein in response to a feedback signal the movably mounted mirror maintains the output beam at a same position at the output coupler.

29. The system of claim 28, wherein the movably mounted mirror holds the intracavity beam at a fixed position relative to the aperture to maintain a stability of the output beam.

30. The system of claim 29, wherein the stability is a stability of output beam wavelengths.

31. The system of claim 28, wherein the movably mounted mirror is positioned between the aperture member and the end mirror.

32. The system of claim 28, further comprising:
a beam splitter positioned at an exterior of the resonator cavity; and
a detector at the exterior of the resonator cavity and positioned to receive at least a portion of the output beam and produce the feedback for the movably mounted mirror.

33. The system of claim 1, wherein the cavity comprises:
an end mirror and an output coupler defining a resonator cavity for an intracavity beam and producing an output beam with selected spectral components;
a gain medium positioned in the resonator cavity;
an aperture member positioned in the resonator cavity in a path of the intracavity beam, the aperture member defining an aperture that provides a low loss intracavity beam path for a range of spectral components;
a first prism pair with first and second sides and positioned between the aperture member and the output coupler, wherein when the intracavity beam travels from the first side to the second side the first prism pair creates a spatial spread process of the range of spectral components, and from the second side to the first side reverses the process; and
a movably mounted mirror, wherein in response to a feedback signal the movably mounted mirror maintains the output beam at a same position at the output coupler.

34. The system of claim 33, wherein the movably mounted mirror holds the intracavity beam at a fixed position relative to the aperture to maintain a stability of the output beam.

35. The system of claim 34, wherein the stability is a stability of output beam wavelengths.

36. The system of claim 33, wherein the movably mounted mirror is positioned between the aperture member and the end mirror.

37. The system of claim 28, further comprising:
a beam splitter positioned at an exterior of the resonator cavity; and
a detector at the exterior of the resonator cavity and positioned to receive at least a portion of the output beam and produce the feedback for the movably mounted mirror.

38. The system of claim 1, wherein the cavity comprises:
an end mirror and an output coupler defining a resonator cavity for an intracavity beam and producing an output beam with selected spectral components;
a gain medium positioned in the resonator cavity;
a first prism pair with first and second sides and positioned in the resonator cavity;
a second prism pair with first and second sides and positioned between the first prism pair and the output coupler;
an aperture member positioned between the first and second prism pairs in a path of the intracavity beam, the aperture member defining an aperture to create the output beam;
a movably mounted mirror, in response to a feedback signal the movably mounted mirror maintains the output beam at a same position at the output coupler; and
wherein when the intracavity beam travels from the first side to the second side of second prism pair, the second prism pair creates a spatial spread process of the spectral components, and when traveling from the first side to the second side of the first prism pair, the first prism pair reverses the process.

39. The system of claim 38, wherein the movably mounted mirror holds the intracavity beam at a fixed position relative to the aperture to maintain a stability of the output beam.

40. The system of claim 39, wherein the stability is a stability of output beam wavelengths.

41. The system of claim 39, wherein the movably mounted mirror is positioned between the aperture member and the end mirror.

42. The system of claim 38, further comprising:
a beam splitter positioned at an exterior of the resonator cavity; and
a detector at the exterior of the resonator cavity and positioned to receive at least a portion of the output beam and produce the feedback for the movably mounted mirror.

43. An optical system, comprising:
a pump source that produces a first output beam;
a cavity pumped by the first output beam and producing a second output beam;
a first power monitor positioned to receive at least a portion of the second output beam the first power monitor providing an input to a summing junction coupled to the pump source; and
wherein in response to a signal from the power monitor an efficiency of the cavity is maximized by adjusting a position of the first output beam relative to the cavity.

44. The system of claim 43, wherein the signal is used to maintain constant power of the second output beam.

45. The system of claim 44, further comprising:
a second power monitor;
a summing junction coupled to the second power monitor and positioned to receive at least a portion of the first output beam to the feedback to maintain constant power of the first output beam.
